(19) United States
(12) Patent Application Publication
(10) Pub. No.: US 2017/0081874 A1
(43) Pub. Date: Mar. 23, 2017

(54) SELF-STERILIZING DOOR HANDLE

(71) Applicant: Christopher C. Daniels, Renton, WA (US)

(72) Inventor: Christopher C. Daniels, Renton, WA (US)

(21) Appl. No.: 14/863,212

(22) Filed: Sep. 23, 2015

(51) Int. Cl. E05B 1/00

(52) U.S. Cl. CPC E05B 1/0069; E05B 1/003; E05B 1/0015; E05Y 2900/114

(57) ABSTRACT

Disclosed herein is an innovative self-sterilizing door handle. The innovation features various door handle shape embodiments where the grasping portion of the handle is made from light-guiding material capable of low attenuation of UVB and UVC light. UV light may be guided into the grasping portion by optical fibers extending from a source comprising an array of LEDs capable of emitting UVB or UVC light. The light source may be integrally formed as part of the door handle hardware. In addition, the surface of the grasping portion of the innovative self-sterilizing handle may be coated with nano-particulate metal oxides.

### FIELD OF THE INVENTION

This innovation relates to self-sterilizing and self-sanitizing door handles.

### BACKGROUND

Microbes are transmitted easily by contact with inanimate surfaces that have been contaminated. In particular, door knobs and door handles, especially if deployed in public places, are ready fomites for contact transfer of micro-organisms from person to person, both pathogenic and benign. This is of particular concern in public restrooms. Examples of communicable diseases that can be spread this way include conjunctivitis, hepatitis A and B, herpes simplex, influenza, common cold, measles, pertussis and adeno-/rhinoviruses. The microorganisms that cause these diseases typically survive on the surface of a door handle for hours or days. For example, the influenza virus can survive from 2 to 8 hours on inanimate surfaces.

A large issue is touching door handles to exit a restroom after washing one's hands. This is to no avail if the handle is contaminated. Door handles in public places other than in restrooms are equally subject to microbial contamination, especially in high-traffic locations such as stores, cinemas, shopping centers, sports arenas, etc.

### SUMMARY

The instant innovation is a self-sterilizing door handle comprising a light-guiding grasping portion adapted to direct ultraviolet (UV) light from a built-in source along the surface of the grasping portion, where a substantial amount of bacteria and other micro-organisms left behind on the surface of the grasping portion will be destroyed within a short time after being handled. Preferably, the grasping portion is a solid rod or tubular structure that couples and guides UV light having an appropriate wavelength range, where UV light may undergo internal reflections from the surface boundary of the grasping portion structure. Light that manages to escape through the surface boundary exposes adhering micro-organisms and may then disinfect the surface of the grasping portion.

The UV spectrum is divided into three regions, UVA having a wavelength range of 320-400 nm, whereas UVB falls in the range of 280-320 nm, and UVC ranges from 100-280 nm. UVC is particularly effective at disinfection and anti-microbial activity, whereas UVB is also effective. The light source is preferably a LED (light-emitting diode) source that is capable of emitting UVB and/or UVC light. However, non-solid state sources such as fluorescent and incandescent bulbs capable of the same emissions may be used as well. In some embodiments, the grasping portion may be shaped as a conventional bar handle of a door, and in other embodiments may be in the shape of a knob or a lever. In other embodiments, the grasping portion may be a latch, such as that used to secure a toilet stall door.

Further embodiments include photo-active coatings placed on the surface of the grasping portion to enhance the effect of the UV light on the microorganisms. One such coating is a thin layer of nano-crystalline titanium dioxide (TiO₂), which has been shown to have self-disinfecting and self-cleaning properties when interacting with white light. In this application, the UV light may be partially absorbed by the TiO₂ layer, which invokes photoelectrochemical reactions to occur directly or indirectly with adsorbed microbes. These reactions are oxidative in nature, and may form free radicals of oxygen that act similarly to bleach. When the UV light interacts directly with the microbe, it may primarily damage the DNA and RNA of the organism, preventing successful cell division and replication, or prevent the manufacture of essential proteins and enzymes for metabolic functions. These two consequences eventually destroys the organism.

In a preferred embodiment, the light source is an array of LEDs. In other embodiments, the light source is a single LED. In yet other embodiments, the light source is a mercury bulb or fluorescent bulb. LED-type light sources are preferable because they use low power and are highly efficient, an advantage for a door installation. The installation is superficially a typical door handle, knob or latch, where the handle is installed at the position of a conventional handle or knob, along one edge of the door at an adequate height. The instant innovation is adapted to be self-sufficient in terms of power supply and maintenance. Preferably, the LED source is powered by one or more batteries. Alternatively, the LED source may be powered by a mains voltage, where a power cable is routed from the door frame to the door, through which it is routed to the LED source in the handle. In other embodiments, the LED source is not directly coupled to the grasping portion, but is located remotely from the grasping portion. An optical fiber or optical fiber bundle may then be used in the intervening space to couple the light from the source to the handle. The source may be embedded in the body of the door. Preferably, the inventive self-sterilizing handle is a self-contained unit, having the grasping portion integral with the light source.

### BRIEF DESCRIPTION OF THE DRAWINGS

FIG. 1a. Oblique view of hollow U-shaped handle grasping portion embodiment of the innovative self-sterilizing door handle.

FIG. 1b. Cross sectional view of FIG. 1a.

FIG. 1c. Frontal view of top of FIG. 1a.

FIG. 1d. Oblique view of solid U-shaped handle grasping portion embodiment of the innovative self-sterilizing door handle.

FIG. 1e. Cross-sectional view of FIG. 1d.

FIG. 1f. Oblique view of one straight grasping portion embodiment of the innovative self-sterilizing door handle.

FIG. 1g. Cross-sectional view of the embodiment of FIG. 1f, revealing interior details.

FIG. 2a. Optical configuration of LED array light source. Rectangular embodiment

FIG. 2b. View of circular embodiment of LED array.

FIG. 2c. Cross-sectional view of LED light source optics showing details.

FIG. 3a. Oblique view of doorknob embodiment of innovative self-sterilizing door handle.

FIG. 3b. Cross-sectional view of doorknob embodiment, showing details of light source and coupling of light to the grasping portion.

FIG. 3c. Alternative conical shaped embodiment of doorknob handle.

FIG. 3d. View of alternative embodiment of conical handle attached to a door.

FIG. 4a. Oblique view of rotatable latch embodiment of self-sterilizing door handle.

FIG. 4b. Exploded view of rotatable latch handle.

FIG. 4c. Alternative shape embodiment of grasping portion of rotatable latch handle.

FIG. 4d. View of lever grasping portion embodiment of rotatable latch handle.

### DETAILED DESCRIPTION

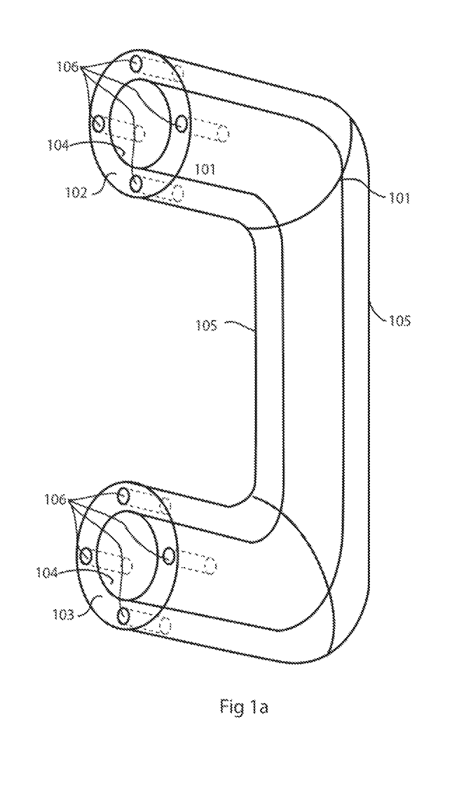

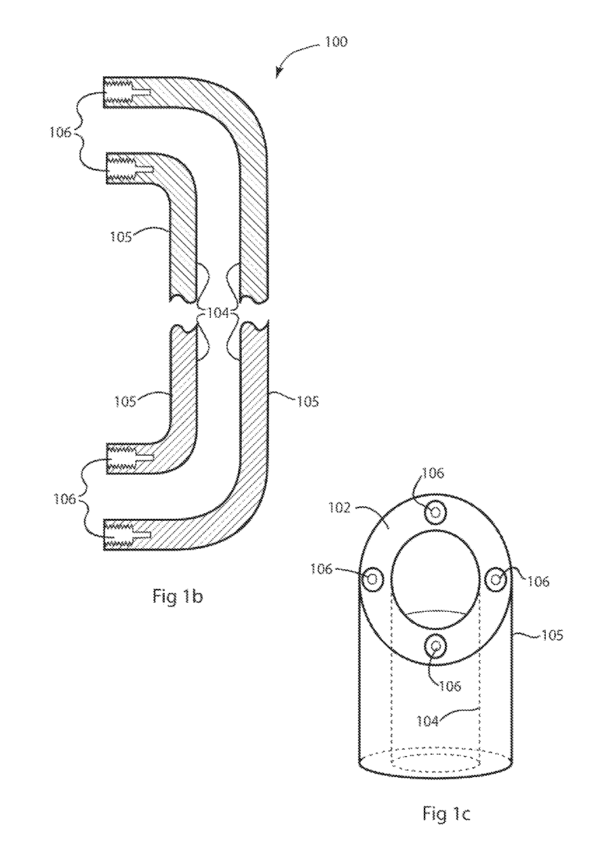

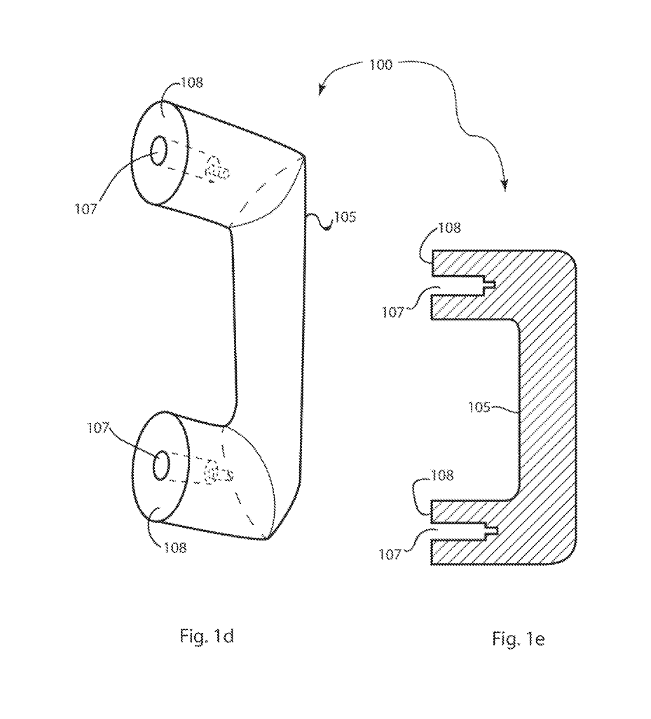

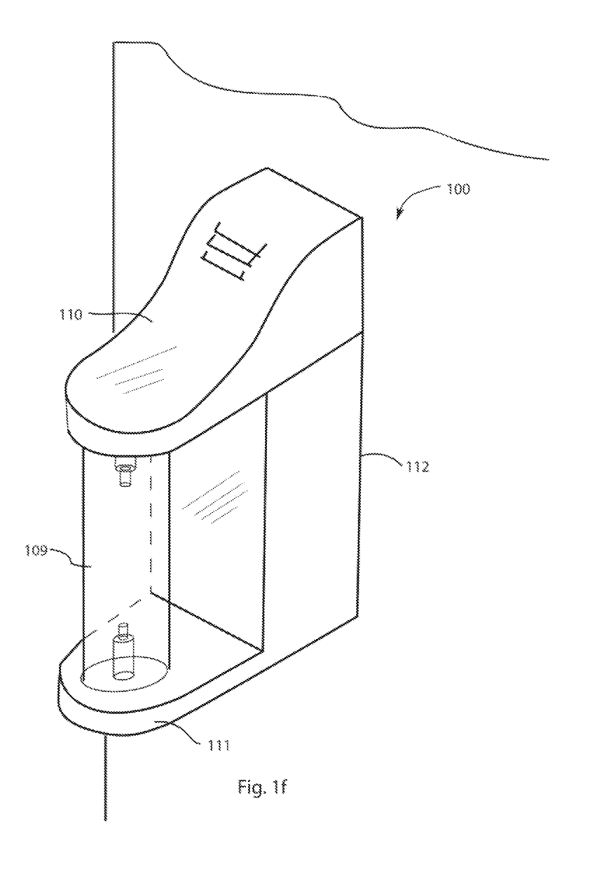

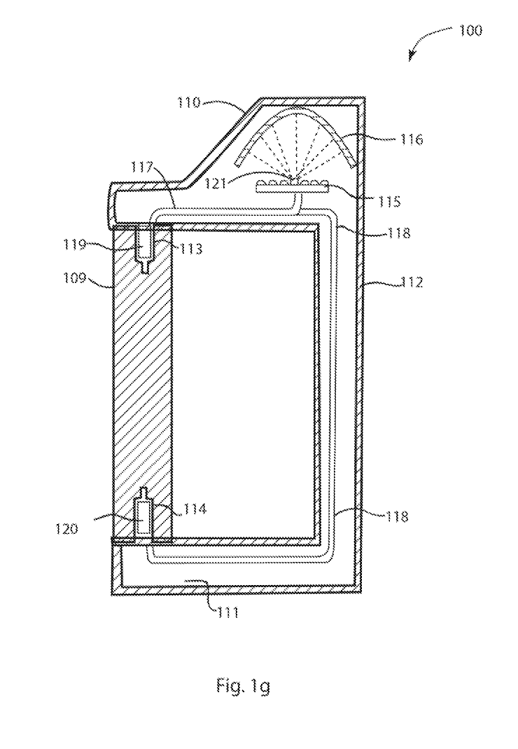

A first embodiment of the innovation is shown in FIG. 1. A U-shaped bar grasping portion 100 of the handle is shown, having a hollow interior 101. The bar handle is effectively a tube bent into a U-shape, having advantages for light guiding. The light is introduced by coupling ends of optical fibers into the flat terminal faces 102 and 103 of the handle grasping portion 100. The hollow aspect of the inventive grasping portion 100 is advantageous for coupling light into the solid portion of the grasping portion, as the light traverses through a smaller cross section, resulting in less absorption of the light by the guiding material. In addition, the interior surface 104 of the hollow handle 100 may be coated with a reflective layer to direct light toward exterior surface 105, resulting in more UV light intensity incident on the grasping surface of handle 100.

A plurality of optical fibers may be used for optimal coupling of light into the handle, where the oblique view of FIG. 1a reveals the flat ends 102 and 103 of the U-shaped tubular handle 100 having a plurality of insert wells 106 machined or formed in ends 102 and 103 for receiving and securing fiber optic couplers. The handle grasping portion 100 itself is preferably made from polymers that are substantially transparent to UVB and UVC. One example of such a polymer are the cyclic olefin copolymers (COC) from Topas Advanced Polymers. COC polymers have very high transmittance to ca. 220 nm (70% transmittance at 280 nm), readily transparent to UVB and UVC, and is mechanically very strong (Young's modulus of 2-3 GPa). Another suitable material is polystyrene. Other materials with suitable UV transmission spectra and mechanical properties may also be considered. In some embodiments, UV transmitting acrylic plastics may be used, such as Acrylite® UV transmitting acrylic that is substantially transparent to UVB.

The cross-sectional view in FIG. 1b shows the details of the insert wells 106 machined into the ends of the U-shaped handle grasping portion 100. For clarity, a zoom frontal view of grasping portion 100 is shown in FIG. 1c, detailing flat end 102 of grasping portion 100, showing a pattern of four insert wells formed in the flat end 102. The configuration of four insert wells is advantageous to introduce light from a source by optical fiber equally around the perimeter of grasping portion 100. Optically, light is coupled into the body of the handle at the interface between the fiber optic couplers and the end of the wells. By way of example, the refractive index, of a COC polymer may be approximately 1.5, close to that of inorganic glass or quartz used in the coupling optics. Therefore, a suitable refractive index match may be easily obtained between the fiber optic coupler and the body of the handle, without resorting to a gradient method.

An alternative embodiment of this form factor is shown in FIG. 1d, where the U-shaped handle grasping portion 100 is made from a solid rod of material. In this embodiment, a single insertion well 107 is shown bored into each of ends 108. FIG. 1e shows in a sectional view the details of an exemplary disposition and shape of insertion wells 107. In other embodiments, multiple insertion wells may be bored into ends 108, as shown if FIG. 1a-c. The solid design guides UV light across the grasping portion across a wider section than in the hollow embodiment of FIGS. 1a-c and described above.

An alternative embodiment is shown in FIG. 1f, where the UV-transparent grasping portion is a straight cylinder 109 disposed between upper and lower brackets 110 and 111, respectively. Brackets 110 and 111 may extend forward from rear mounting plate 112. According to the present embodiment, the upper bracket 110 houses the UV light source and optics. Optical fibers may be routed to grasping portion 109 though both upper and lower brackets 110 and 111, respectively, and engage with UV-transparent grasping portion 109 via insert wells (not shown) as in the embodiments described above. These details are shown in FIG. 1g, where the inventive embodiment (FIG. 1f) is shown in cross-sectional view to expose the light source 115, which is disposed within upper bracket housing 110. Disposed along with light source 115 is parabolic mirror 116. Split optical fibers 118 and 119 emanate from fiber optic coupler 121 shown disposed at the center of UV light source 115, and coincides with the focal point of parabolic mirror 116.

As described earlier for the afore-mentioned embodiments, once collected, UV light is routed to UV-transparent grasping portion 109 ensconced between upper and lower brackets 110 and 111, respectively. Optical fibers 118 and 119 terminate in optical fiber terminations that are disposed in insertion wells 113 and 114, which are formed in the ends of grasping portion 109. UV light entering the material of grasping portion 109 disperses in the fashion described above. The present embodiment may be mounted on a door via mounting plate 112.

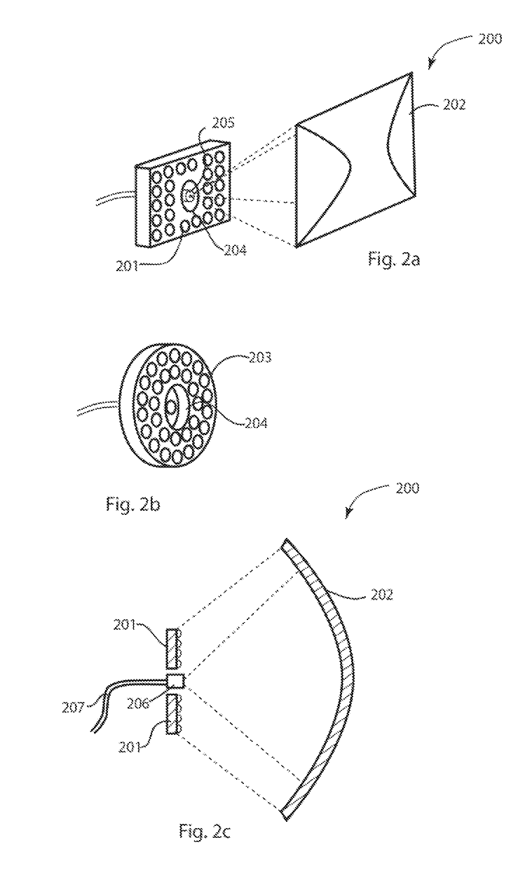

An example of an optical coupling system is shown in FIG. 2a. The innovative system 200 comprises a LED array light source 201 comprising a plurality of individual LEDs and a parabolic mirror 202, as shown in FIG. 2a. The LED array 201 may be also arranged on a circular substrate 203, as shown in the embodiment of FIG. 2b, in addition to the rectangular substrate of FIG. 2a. The substrate of LED array 201 (and 203) may have an aperture 204 in the center to allow a coupler for an optical fiber to be placed at the focal point of parabolic mirror 202. Aperture 204 may be large enough to pass light reflected from the parabolic mirror to a focal point behind the LED array. At the focal point may be a fiber optic coupler or lens focusing the light into the end of an optical fiber.

The arrangement shown in FIG. 2a shows the face of a coupler 205 positioned within aperture 204, coinciding with the focal point of mirror 202. FIG. 2c shows a schematic of the component configuration of light source 200, with cross-sectional views of LED array substrate 201 (203), parabolic mirror 202. Coupler 206 is shown inserted into aperture 204, where its face coincides with the focal point of mirror 202. Coupler 206 is trailed by optical fiber 207. The focal point may advantageously be located within the plane of the LED array substrate, or just behind it. The parabolic mirror may be dimensionally larger than the LED array substrate to collect at least a portion of the light emanating from the LED array, and re-focus it to the center of the array where it may be coupled to an optical fiber via a coupler or separate lens.

In other embodiments, a transparent quartz or silica lens may replace the parabolic mirror. The lens may also be made from polymers with high UV transparency, such as the COCs mentioned above. In this arrangement, the light source and the optical fiber coupler are on opposite sides of the focusing lens. To be effective as a sterilization agent, the luminosity of the UVB and UVC is preferably sufficient to deliver a dose strong enough to reduce the cell count by a factor of 90% within 60 seconds. The time period for effective sterilization of the grasping portion of the door handle is chosen to be effective for use in a high-traffic area, such as a public restroom, with a high frequency of handling the grasping portion.

By way of example, a 90% (1 log) reduction of E. coli bacteria requires ca. 3,000 μWs/cm² energy dose of UV (based on 253.7 nm wavelength), whereas a 99% (2 log) reduction requires 6,600 μWs/cm² energy dose of UV (based on 253.7 nm wavelength) [source: www.americanairandwater.com/uv-facts/uv-dosage.htm]. Accordingly, a 60 second exposure would necessitate a UV intensity of 50 μW/cm² for a 1 log reduction, and 110 μW/cm² for a 2 log reduction (based on 254 nm wavelength). Preferably, the light source of the instant innovation provides sufficient UV intensity to achieve at least a 1 log reduction of E. coli in 10 seconds or less. This exposure time requires at least 300 μW/cm² of distributed UV light (based on 254 nm) impinging on the light-guiding surfaces of the grasping portion. It is understood by those skilled in the art that the dose times need to be adjusted for wavelengths other than 254 nm, with longer wavelengths requiring longer dose times.

As a practical example, a LED array may be constructed from individual LED elements capable of generating sufficient radiant flux. One example of such a device is UVC LED part number E273SL by International Light Technologies, which produces 1 mW of radiant flux between 273-283 nm. The LED devices have dimensions of 3.45×3.45×1.9 mm. Thus, a 100-element close-packed LED array (10×10) composed of this device occupies a square region of approximately 35×35 mm. The total radiant flux output from this array is approximately 100 mW. Assuming a cylindrical light-guiding grasping portion having a length of 10 cm and a diameter of 2 cm, a total outer surface area of approximately 63 cm² is available for contact by users' hands. Based on this surface area, a total minimum radiant power of 20 mW is required to provide a distributed radiant flux of 300 μW/cm². Based on the E273SL unit, this minimum radiant power may be provided by an array of at least 20 LEDs, or a square 5×5 array. However, with a typical optical coupling efficiency of approximately 60%, a larger array of at least 40 LEDs may be required. Typically, each LED consumes 20 mA at full brightness, and operates with approximately 6 Vdc. A small switched-mode power supply supplying 6 Vdc at 1-2 A provides sufficient electrical power for up to a 100-element LED array.

To be effective, a substantial portion of the UV light entering the light-guiding grasping portion must be able to be transmitted across the surface of the grasping portion to interact with adsorbed microorganisms. There are multiple ways this can happen. First, UV light coupled into the medium of the grasping portion may be introduced over a narrow solid angle, and therefore may be launched at an arbitrary angle of incidence with respect to the grasping portion surface normal. Persons skilled in the art will recognize that rays introduced at angles less than the critical angle will undergo refraction, therefore allowing a portion of the incident light to leak across the interface on each internal reflection. Light incident at angles greater than the critical angle undergo total internal reflection, and does not leak across the interface.

This phenomenon is known in the art as attenuated total internal reflection (ATR) of the light within the medium of the grasping portion. The degree of attenuation depends on the percentage of light leaked across the surface into the air and therefore lost. The loss due to ATR is a function of the angle of incidence. Therefore, the primary angle of incidence may be freely adjusted for ATR. UV light leaked across the interface may interact with adsorbed microorganisms and neutralize them. The dose may be adjusted by fixing a primary angle of incidence. Secondary effects are also important, and these are primarily scattering events due to imperfections at the surface of the grasping portion that diffuse the internal reflections. Scattering events may scramble the initial travel path of the incident light, and disperse the light at all angles within the medium of the grasping portion, causing some rays to undergo total internal reflection. The outcome is that in some embodiments, UV light dosage is provided by relying on the angle of incidence being below the critical angle, and upon internal scattering.

Embodiments of the instant innovation provide enhancement of internal scattering. This may be achieved by providing a roughened grasping portion surface, such that the surface is diffusive and translucent. The diffusive surface enhances the distribution of light along the length of the grasping portion, thereby allowing a more uniform dose along the length of the grasping portion so that microorganisms are neutralized with substantially uniform UV light intensity along the length.

Further embodiments of the innovation provide anti-microbial metal oxide films deposited on the surface, such as nanoparticulate titanium dioxide (TiO₂). In addition, zinc oxide, cuprous oxide, cupric oxide, tungsten oxide, and nanoparticulate silver are known to form antimicrobial films or coatings. Providing an antimicrobial metal oxide coating or film directly on the surface of the grasping portion medium allows a known optical phenomenon of frustrated total internal reflection (FTIR) to occur. FTIR allows light incident above the critical angle to escape across the interface and is then available to interact with adsorbed microorganisms. Scattering within the film may also occur, further enhancing the uniformity of the light across the length of the grasping portion.

Moreover, the TiO₂ and other metal oxide coatings may be antimicrobial. Interaction with UV light creates photoelectrochemcal reactions that may locally produce ozone and oxygen radicals that act as disinfectants when contacting adsorbed microorganisms.

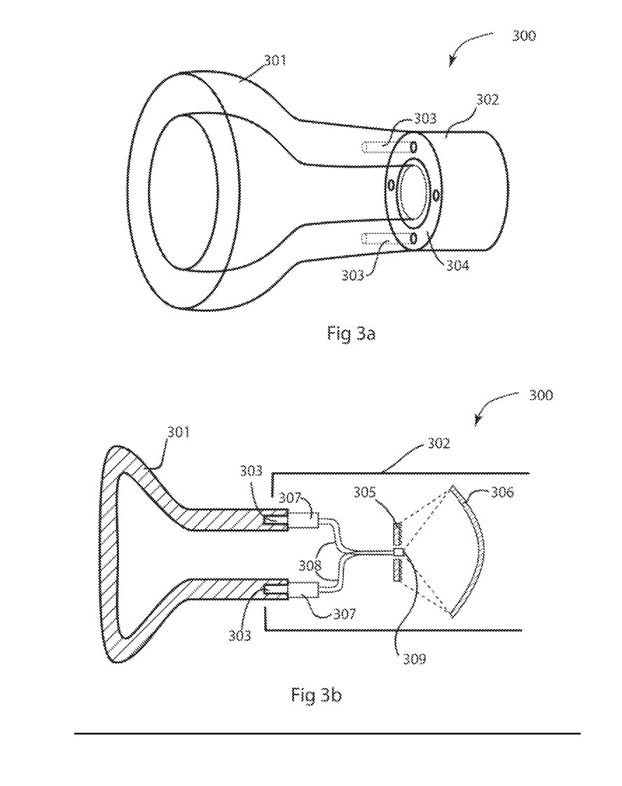

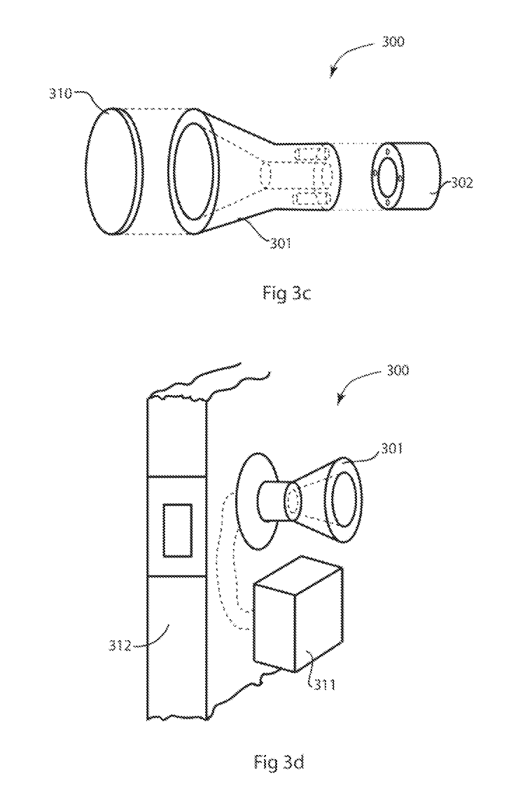

In other embodiments, the light-guiding handle is rotatable. In one embodiment, the handle is in the shape of a door knob, as shown in FIG. 3a. The door knob embodiment 300 comprises a knob-shaped grasping portion 301, which may be fashioned in a similar manner similar to the U-shaped handle embodiment shown in FIG. 1. That is, grasping portion 301 may have a hollow body, where light is coupled into the shell of the hollow body. To this end, insertion wells 303 are shown to be formed at the lower face 304 of grasping portion 301.

Knob-shaped grasping portion is also shown having base 302 affixed at lower face 304. Base 302 may serve to contain a light source and optics to couple light into grasping portion 301. FIG. 3b shows these details in a cross-sectional view of knob-shaped handle 301. Optical fiber couplers 307 are affixed to grasping portion 301 via insertion wells 303, and may be attached by adhesive, press fit, or bolted on. Leading backwards from couplers 307 are optical fibers 308, which lead to another coupler 309 from which they split into two separate fibers. As shown first in FIG. 2c and discussed above, coupler 309 is positioned at the focal point of mirror 306, and may coincide with the plane of LED array 305, or be positioned in front or behind LED array 305. Dashed lines between LED array 305 and parabolic mirror 306 show the path of light emitted from LED array 305 and reflected and focused by parabolic mirror 306 to impinge in the front plane of coupler 309. The light source assembly may be housed in base 302, which also serves to receive the shaft extending through the door to the latching mechanism.

Knob-shaped handle is also made of a material that is substantially transparent to UVC and has a refractive index larger than 1.0 (air) to allow wave guiding action. The door knob handle may be substantially constructed as a standard door knob, that is, it may have a rod connecting two knobs on opposite sides of the door, and a latch actuation mechanism. The difference afforded by the instant innovation is the addition of the light source and connectivity between the light source and the light-guiding rotatable handle.

Referring to FIG. 3c, a different shape embodiment of the rotating door knob handle 300 is shown. Here, the light-guiding grasping portion 301 is a conical-shaped section, adapted to be affixed to base 302. The conical or cylindrical light guide may be capped by a circular plate 310 placed in the center of the conical light-guiding grasping section 301. An alternative embodiment is shown in FIG. 3d, where light source housing 311 is shown affixed to door 312, below the innovative door handle 300. Housing 311 may contain the light source and optics, alleviating the need to house the optics and light source in the base. Hidden lines show embedded optical fibers routed inside the door body to bring the light out to grasping portion 301.

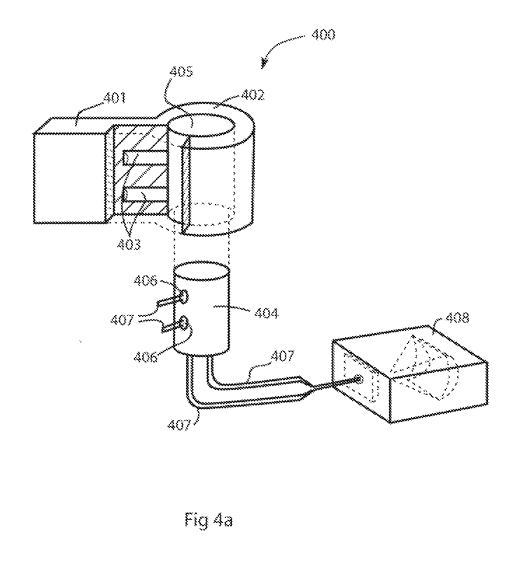

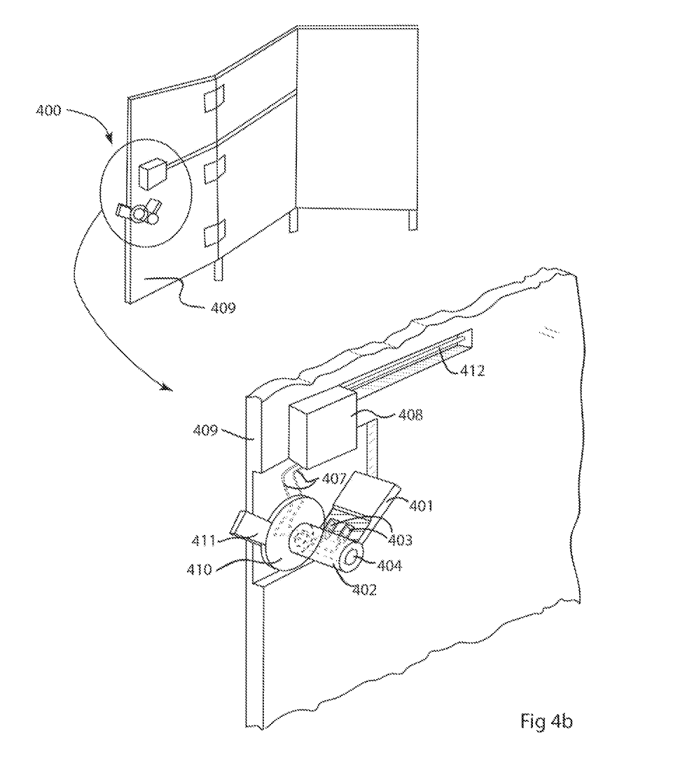

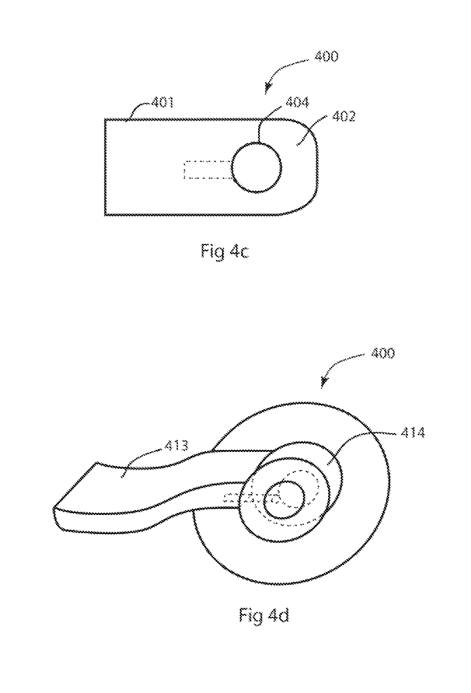

In FIG. 4a, a latch handle embodiment 400 is shown that is primarily adapted to fit on toilet or restroom stall doors, but may be used for other types of doors. An exploded view of latch handle embodiment 400 reveals construction details. The instant embodiment has UV-transparent tab grasping portion 401 extending from shroud 402 surrounding embedded shaft 404. Light-guiding grasping tab 401 and shroud 402 are shown formed from a single molded piece of UV light-transparent plastic, but may also be formed by other methods and materials. Grasping tab 401 may be substantially flat for grasping with fingers, as depicted in FIG. 4a, and may be transparent to UV light. The flat grasping tab 401 may be substantially rectangle-shaped or semi-circular (or ellipsoidal), as a tab extension from shroud 402. Alternatively, grasping tab 401 may be translucent, whereby the surface region of the grasping portion is diffusive to light, as described above.

The cutaway view of grasping tab 401 shown in FIG. 4a reveals optical fiber head insertion wells 403 for receiving optical fiber output heads. Shaft 404 is shown in the exploded view to insert into the hollow region 405 of shroud 402, and may be further coupled with a rotating door latch mechanism (not shown). Shaft 404 may be metallic or made from polymers, and dimensioned to be press fit or glued into the hollow region 405 of shroud 402. Hollow region 405 may be dimensioned to be press fit over shaft 404, or may insert into the rotating body of the latch directly. Shroud 402 surrounding shaft 404 may also be fabricated as a separate piece from the grasping portion of the latch handle. In this way, insertion wells 403 may be machined or otherwise formed in the grasping portion to receive the optical fibers. Shaft 404 may have through passage holes 406 through which optical fibers 407 extend to seat within insertion wells 403, preferably with fiber optic couplers.

Optical fibers 407 may be routed through shaft 404 of the rotating latch, as shown in FIG. 4a, extending from light source enclosure 408. Shaft 404 may have a hollow interior through which the optical fibers 407 are routed. Ends of optical fibers are then coupled to the flat grasping portion 401 of the latch handle embodiment optical fiber heads wherein they terminate in insertion wells 403 machined into the grasping portion 401 as shown in FIG. 4a.

As the rotating body (in the form of shaft 404) of the latch 400 may embedded in a door, such as a toilet stall door 409 as shown in FIG. 4b, optical fibers 407 may be routed in the interior of the door from the light source to the rotating body as shown in FIG. 4b. The flexible nature of the optical fibers allows the limited rotation of the shaft without disturbing the seating of the optical fibers in the receiving ports, nor are they damaged by repeated limited rotation. Optical fibers 407 may extend from light source housing 408, which also houses the coupling optics (not shown). Light source unit contained within housing 408 contains a UV light source, such as the LED arrays described above that has low power consumption, and a means of coupling the UV light into an optical fiber, such as the parabolic mirror or lens systems also described in greater detail above, and shown in FIG. 2.

The body of grasping tab 401 preferably surrounds shaft in order to provide a sterile surface around the shaft, as fingers may touch that area of the shaft. Still referring to the embodiment example of FIG. 4b, shaft 404 is affixed to rotating latch base 410, as shown embedded in the interior of door 409 by the cutaway view in FIG. 4b, where door latch 411 is shown extending from base 410 to the exterior of door 409. Because the size of the latch handle embodiment is generally smaller than for the door knob or bar handle embodiments disclosed above, the light source and optics may be housed in a physically separate unit, such as enclosure 408. Optical fibers 407 are shown routed though the interior of door 409 (cutaway view) from housing 408 to the base of shaft 404. Power may be delivered by a small supply connected directly to a mains source routed from a junction box in or on the wall or ceiling of the restroom via an external conduit 412 shown embedded in the interior of door 409 in FIG. 4b. Alternatively, power delivery conduit may be routed on the exterior surface of door 409.

Conduit 412 may be embedded in the interior of the stall door 409, as shown in FIG. 4b, and extending along the stall partition, also shown in FIG. 4b, and may be wired to an ac low voltage source such as a low-voltage transformer that is rectified to 9 Vdc, as an example. Alternatively, a high capacity battery such as a lead-acid battery or AGC battery may be used as a source of power. The light source may be connected to the power source through wiring routed across the stall partition to a source embedded in the wall of the restroom, mounted in the ceiling, or mounted on the exterior surface of the wall.

An alternative embodiment of grasping portion 401 is shown in FIG. 4c. In this embodiment, shroud 402 has a more square shape to facilitate manufacture. The function is the same as for embodiment shown in FIGS. 4a and 4b. Another alternative embodiment is shown in FIG. 4d, where grasping portion 413 of self-sterilizing door handle 400 is manifest in the form of a lever, and more elongated than tab 401 shown in FIGS. 4a-c, allowing for wrapping one's fingers around lever handle 413. Lever handle 413 may be made from a variety of materials that are transparent to UVB and UVC light. Such handles may be used in normal door latch applications, supplanting a knob-shaped handle. This embodiment inherits the other aspects of the embodiments shown in FIGS. 4a-c, such as shroud 414, homologous with shroud 402 in FIGS. 4a and 4c.

As a further embodiment, FIG. 4d shows a lever-shaped grasping portion 413 of self-sterilizing door handle 400 that is also UVB/C transparent. Lever-shaped grasping portion 413 is affixed to shroud 414 that may fit over a rotatable shaft (not shown) that actuates the door latch. As with the previous embodiment, optical fibers may be routed through the rotatable shaft of the door mechanism to seat (light dispersion couplers) in insertion wells formed at the base of the lever grasping portion 413, or where it forms an integral junction with shroud 414. The UV light may then be guided inside the lever-shaped grasping portion. In accordance with the above embodiments, the surface of the grasping portion 413 may be coated with TiO₂ or similar coatings to enhance the self-sterilizing effect of the channeled UV light.

It is understood by persons skilled in the art and by others that the specific descriptions of the embodiments of the innovative self-sterilizing door handle disclosed herein are exemplary, and not to be construed as limiting. It is further understood that variations of these embodiments are equivalent and do not depart from the spirit and scope of the innovations described and claimed below.

I claim:

1. A handle assembly, comprising:
(i) an ultraviolet light source;
(ii) a handle having a grasping component at least partially comprising a light-guiding portion, said light-guiding portion having a surface adapted to be grasped by a human hand, the handle grasping component having an optical coupling port disposed thereupon; and
(iii) a light transferring component optically coupled to the optical coupling port of the grasping component of said handle and optically coupled to the ultraviolet light source for receiving light from the ultraviolet light source and coupling said light into the light-guiding portion of said grasping component of the handle.

2. The handle assembly of claim 1, wherein the grasping component of the handle comprises a tubular shell section of light-guiding material, said tubular shell section having two ends, said optical coupling mechanism disposed on at least one of the two ends of the tubular shell section of light-guiding material.

3. The handle of claim 2, wherein the optical coupling mechanism comprises at least one optical fiber coupling port disposed on the light guiding portion.

4. The handle of claim 1, wherein the light transferring component comprises at least one optical fiber.

5. The handle of claim 1, wherein the ultraviolet light source comprises a light emitting diode array having at least one UV light emitting diode.

6. The handle of claim 1, wherein the grasping component comprises a solid cylindrical section of light-guiding material, said solid cylindrical section having two ends, said optical coupling mechanism disposed on at least one of the two ends of the solid cylindrical section of light-guiding material.

7. The handle of claim 1, wherein the grasping component comprises a substantially knob-shaped body of light-guiding material, said knob-shaped body having at least one end, the vicinity of which the optical coupling mechanism is disposed for coupling light from the light-transferring component into the knob-shaped body.

8. The handle of claim 1, wherein the grasping component comprises a substantially conical body of light-guiding material, said conical body having at least one end, the vicinity of which the optical coupling mechanism is disposed for coupling light from the light-transferring component into the conical body.

9. The handle of claim 1, wherein the grasping component comprises a tab composed of light-guiding material, said tab so dimensioned as to be graspable by human digits, having a distal end and a proximal end, said proximal end anchored to a rotating portion of said handle and said distal end extending therefrom, wherein the optical coupling mechanism is disposed in the proximity of said proximal end for coupling light from the light-transferring component into the tab of light-guiding material.

10. The handle of claim 9, wherein the tab is a part of a bathroom stall door latch.

11. The handle of claim 1, wherein the grasping component comprises a lever-shaped handle portion composed of light-guiding material, said lever-shaped handle portion having a distal end and a proximal end, said proximal end integral with a rotating shroud portion of said handle and said distal end extending therefrom, wherein the optical coupling mechanism is disposed in the proximity of said proximal end for coupling light from the light-transferring component into the lever-shaped handle portion of light-guiding material.

12. The handle of claim 1, wherein the grasping component is coated with a nanoparticulate material selected from the group consisting of titanium dioxide, zinc oxide, cupric oxide, cuprous oxide, tungsten oxide and silver.

13. The handle of claim 1, wherein the grasping component comprises a light-diffusive surface.

14. A self-sterilizing door handle system, comprising:
i) a door;
ii) a latching mechanism disposed on said door for securing said door to a door frame when said door is closed;
iii) a handle coupled to said latching mechanism, said handle having a grasping component comprising a light-guiding portion, the grasping component;
iv) an optical coupling mechanism for receiving light and coupling said light into the light-guiding portion; and
v) an ultraviolet light source optically coupled to the optical coupling mechanism, said ultraviolet light source disposed on said doors.

15. The self-sterilizing door handle system of claim 10, wherein the optical coupling mechanism is one or more optical fibers.

16. The self-sterilizing door handle system of claim 10, wherein the grasping component of said handle comprises a tubular shell section of light-guiding material, said tubular shell section having two ends, said optical coupling mechanism disposed on at least one of the two ends of the tubular shell section of light-guiding material.

17. The self-sterilizing door handle system of claim 10, wherein the grasping component comprises a solid cylindrical section of light-guiding material, said solid cylindrical section having two ends, said optical coupling mechanism disposed in the proximity of at least one of the two ends of the solid cylindrical section of light-guiding material.

18. The self-sterilizing door handle system of claim 10, wherein the grasping component comprises a substantially knob-shaped body of light-guiding material, said knob-shaped body having at least one end, the vicinity of which the optical coupling mechanism is disposed for coupling light from the light-transferring component into the knob-shaped body.

19. The self-sterilizing door handle system of claim 10, wherein the grasping component comprises a substantially conical body of light-guiding material, said conical body having at least one end, upon which the optical coupling mechanism is disposed for coupling light from the light-transferring component into the conical body.

20. The self-sterilizing door handle system of claim 10, wherein the grasping component comprises a tab composed of light-guiding material, said tab so dimensioned as to be graspable by human digits, having a distal end and a proximal end, said proximal end anchored to a rotating portion of said handle and said distal end extending therefrom, wherein the optical coupling mechanism is disposed in the proximity of said proximal end for coupling light from the light-transferring component into the tab of light-guiding material.

21. The self-sterilizing door handle system of claim 10, wherein the grasping component comprises a lever-shaped handle portion composed of light-guiding material, said lever-shaped handle portion having a distal end and a proximal end, said proximal end integral with a rotating shroud portion of said handle and said distal end extending therefrom, wherein the optical coupling mechanism is disposed in the proximity of said proximal end for coupling light from the light-transferring component into the lever-shaped handle portion of light-guiding material.
